(19) United States
(12) Patent Application Publication
(10) Pub. No.: US 2008/0073454 A1
(43) Pub. Date: Mar. 27, 2008

(54) HOUSING FOR HIGH-SPEED ROTATIONAL WOOD CHOPPING CUTTER

(76) Inventor: Yu-Chao Chao, Chang-Hau Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,530

(22) Filed: Sep. 24, 2007

(30) Foreign Application Priority Data
Sep. 25, 2006 (TW) 095217125

(51) Int. Cl. B02C 17/02

(52) U.S. Cl. 241/91

(57) ABSTRACT

A housing for high-speed rotational wood chopping cutter includes parallel plates, one or more expelling portion, and several blocking plates. It can form a solid hollow structure having an isolated storing space. There is a pair of guiding slots for easily installing a high-speed rotational wood chopping cutter inside the storing space. The housing has an ingress for inputting a wood material to be cut and one or more egress portions to expel chopped debris or pieces away due to a centrifugal force caused by high-speed rotation. In this invention, the entire structure is solid and safe. The structure is simple. It has special guiding slots. Plus, it has several expelling modes.

### BACKGROUND OF THE INVENTION

1. Field of the Invention

The present invention relates to a housing for high-speed rotational wood chopping cutter. In which, the entire structure is solid and safe. The structure is simple. It has special guiding slots. Plus, it has several expelling modes.

2. Description of the Prior Art

Traditional small-sized high-speed rotational chopping cutter usually has one or more cutting blades with a relative smaller diameter (such as the diameter is less than 30 cm). Because the size and weigh of such blade is smaller, its related assembling, replacing or repairing work is relatively easy.

If the above-mentioned chopping cutter is modified into a big-sized disk design, the diameter of the disk will exceed 60 cm. Assuming the thickness is 5 cm and this disk is made by a metal, the total weigh of such big-sized disk is quite huge. It is almost impossible to be moved by hand (must use a hanging device to move it). Therefore, its assembling work becomes very difficult.

Also, when the big-sized disk design is adopted, all other related parts will be re-designed. It is very complicated. Hence, it is very difficult to assemble, replace, or repair this chopping cutter or related parts.

Thus, it is needed to invent a new product to overcome the above-mentioned disadvantages and problems.

### SUMMARY OF THE INVENTION

The primary object of the present invention is to provide a housing for high-speed rotational wood chopping cutter. In which, it has a special design of guiding slots so that its assembling and repairing works become very easy.

The next object of the present invention is to provide a housing for high-speed rotational wood chopping cutter. The structure is simple.

The other object of the present invention is to provide a housing for high-speed rotational wood chopping cutter. The entire structure is solid and safe.

Another object of the present invention is to provide a housing for high-speed rotational wood chopping cutter. It has several expelling modes such as expelling to the ground, to one side or both.

### BRIEF DESCRIPTION OF THE DRAWINGS

FIG. 1 is a perspective view of the first preferred embodiment of the present invention.

FIG. 2 is a view showing the first preferred embodiment of the present invention.

FIG. 3 illustrates the present invention before assembling.

FIG. 4 is another view showing the first preferred embodiment of the present invention.

FIG. 5 shows the second preferred embodiment of the present invention.

FIG. 6 is a view showing the second preferred embodiment of the present invention.

FIG. 7 is a perspective view of the third preferred embodiment of the present invention.

FIG. 8A is an enlarged view of a portion of third preferred embodiment of the present invention.

FIG. 8B is another enlarged view of a portion of third preferred embodiment of the present invention.

### DETAILED DESCRIPTION OF THE PREFERRED EMBODIMENT

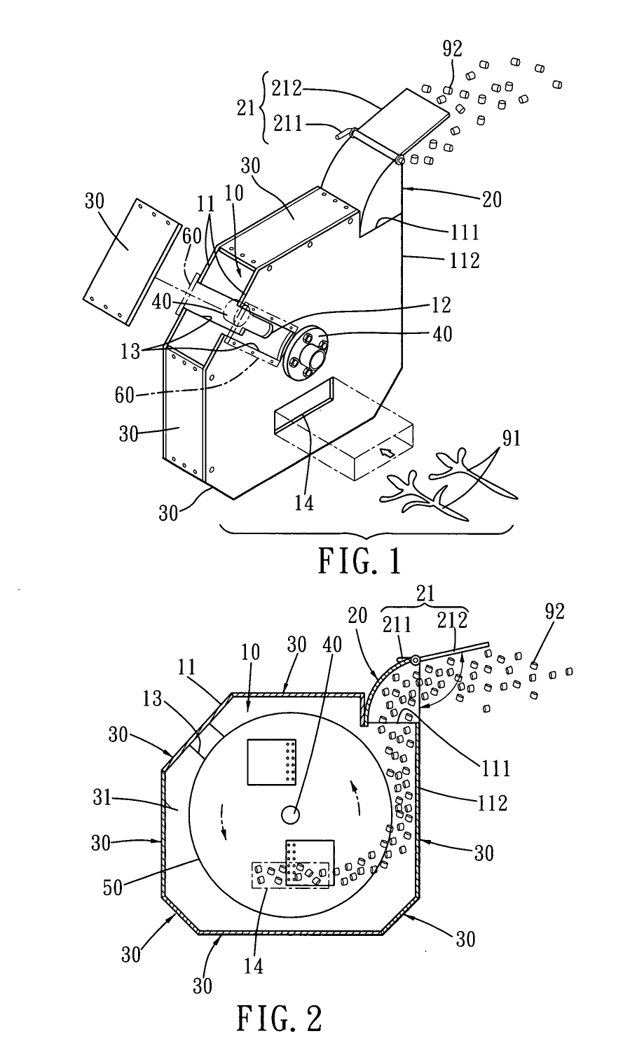

As shown in FIGS. 1, 2, 3 and 4, the present invention is a housing for high-speed rotational wood chopping cutter. In the first preferred embodiment, it comprises a pair of parallel plates 10, at least one expelling portion 20, and a plurality of blocking plates 30.

Concerning the pair of parallel plates 10, it has a pair of outer edges 11, a pair of bearing holders 12, a pair of guiding slots 13 and an ingress 14. The pair of outer edges 11 includes an egress portion 111 and a plurality of lateral plate edge 112. The pair of bearing holders 12 is disposed at a central portion of the housing for securing a pair of bearings 40. The pair of guiding slots 13 (such as sloped guiding slots) includes a pair of guide-in portions 131 and a pair of ending portions 132. The guide-in potions 131 are disposed on a predetermined position of the lateral plates. 112. The ending portions 132 are disposed at the central portion of the housing. This ingress 14 is disposed for inputting a wood material 91 to be cut.

With regard to the expelling portion 20, its function is to expel debris or pieces 92 generated during a wood chopping process (chopped from a wood material 91 like a branch, tree, coconut, bamboo, etc.). Once the wood material 91 is chopped into small debris or pieces 92, they will be quickly expelled out due to a strong centrifugal force (caused by high-speed rotation) at the same time.

About the blocking plates 30, they connect (such as by bolts or by screws) between the parallel lateral plate edges 112 so as to form a substantially isolated storing space 31 for installing a high-speed rotational wood chopping cutter 50.

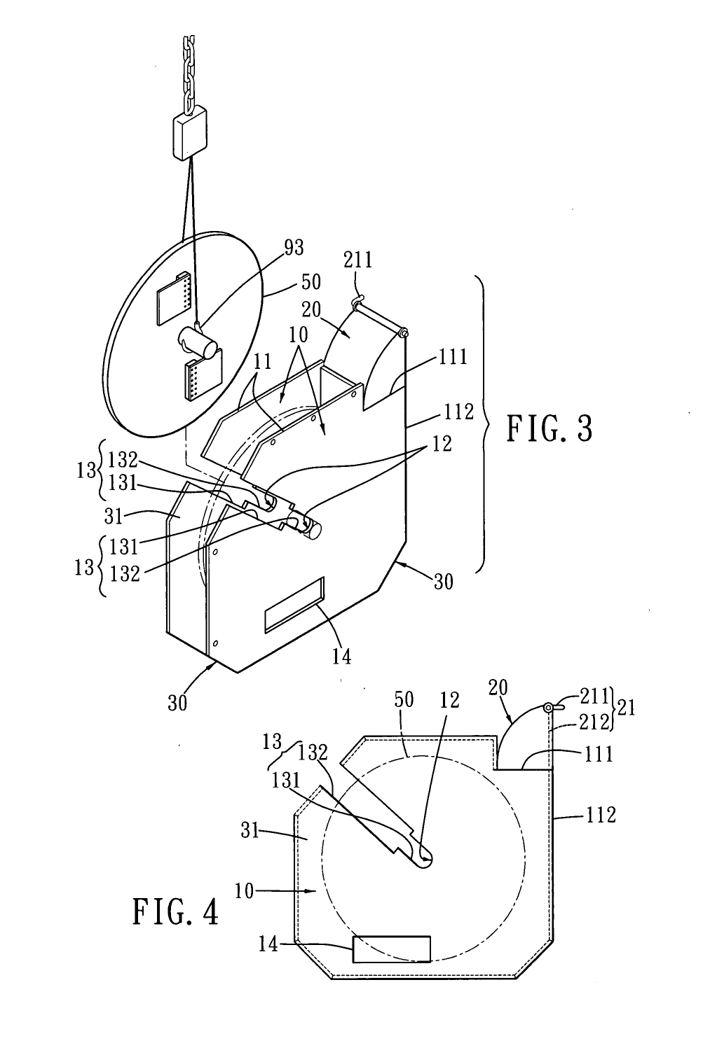

Moreover, by utilizing these blocking plates 30 securing or fixing on the outer edges 11 of the parallel plates 10, it will form a basic structure of the housing for high-speed rotational wood chopping cutter. For example, as shown in FIG. 3, the parallel plates 10 are secured on one side and on the bottom of the outer edges 11.

Next, an operator can control a hook 93 of a hanging device to move this heavy wood chopping cutter 50 to a position roughly above the guide-in portions 131. Then, the operator can make the heavy wood chopping cutter 50 slowly moving along the sloped guiding slots 13 until it arrives the ending portions 132. After which, two bearings 40 are installed with the shaft of the rotational wood chopping cutter 50. Then, they are secured on the bearing holders 12. Finally, the operator can use several blocking plates 30 to secure (or seal) on the top, the other side and all other non-sealed sides of the outer edges 11, so as to form an isolated storing space 31. Hence, the wood chopping cuter 50 is installed inside the isolated storing space 31.

As show in FIGS. 1 and 2, the wood chopping cutter 50 is turned on. Wood material 91 is inputted into the ingress 14 (then into the storing space 31). Once the wood material 91 contacts with the high-speed rotating wood chopping cutter 50, it will be chopped into small debris or pieces 92 immediately. At last, these debris or pieces 92 will be expelled out via the expelling portion 20 due to a strong centrifugal force caused by such high-speed rotation.

As illustrated in FIG. 1, the guiding slots 13 of the parallel plates 10 can be covered by auxiliary covering plates 60. It can avoid any chopped debris or pieces 92 flying out to hurt someone nearby.

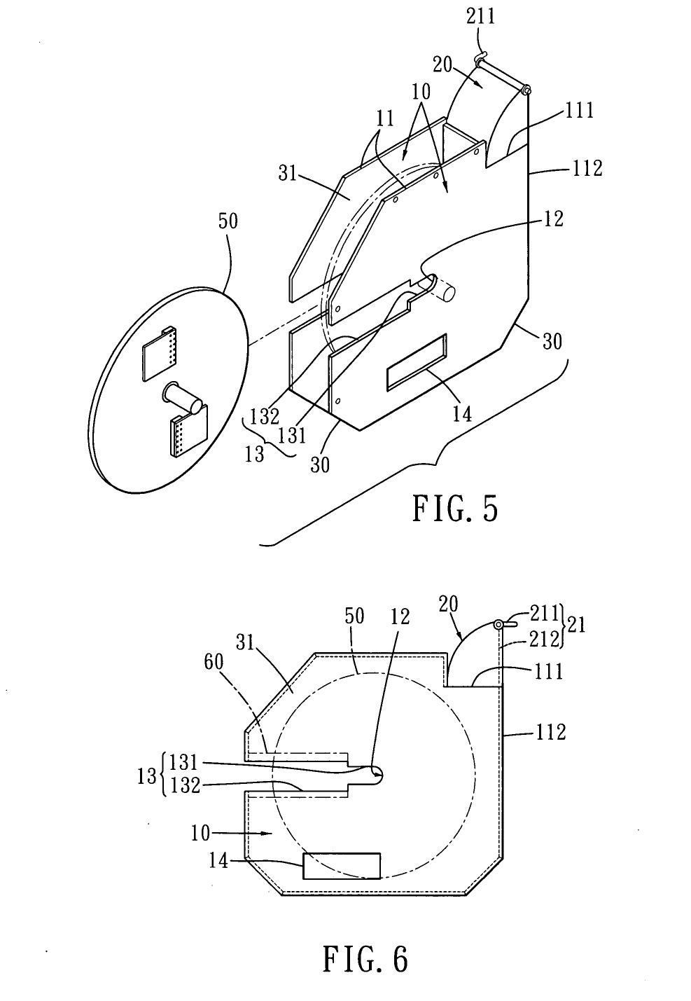

FIGS. 5 and 6 shows the second preferred embodiment of the present invention. It is similar to the first preferred embodiment except its guiding slots 13 are substantially horizontal (not sloped). Of course, these horizontal guiding slots 13 also can be covered by the auxiliary covering plates 60.

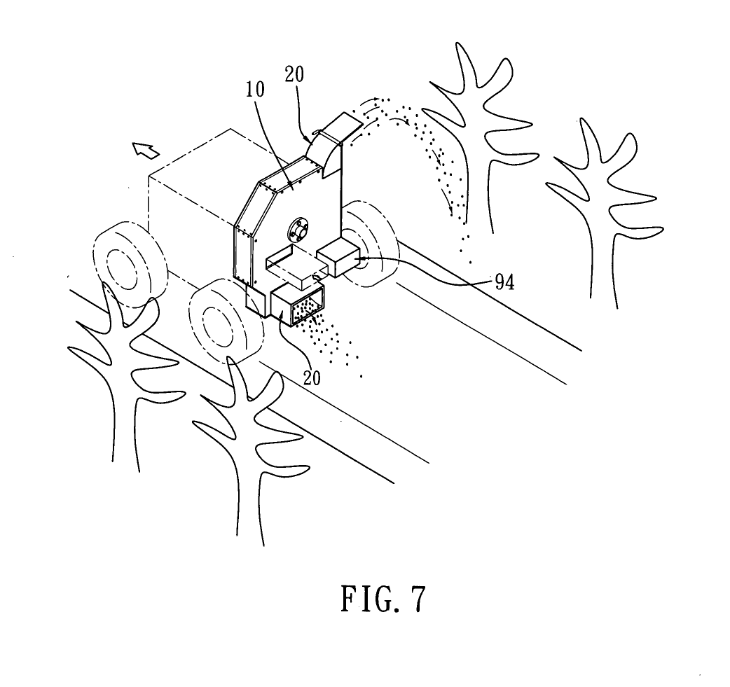

Referring to FIG. 7, it illustrates the third preferred embodiment of the present invention. In which, there are two egress portions 111 (not labeled) and two expelling portions 20. One expelling portion 20 is disposed on the bottom. The other one is disposed on the upper right corner. Therefore, when this invention is installed on a movable vehicle 94, the debris or pieces 92 (chopped from the wood material 91) will fall down (to the moving path on the ground) and move to one side (to the right hand side then falling on the ground near plants). Practically, the operator can select one of them (expel down or up) or both of them.

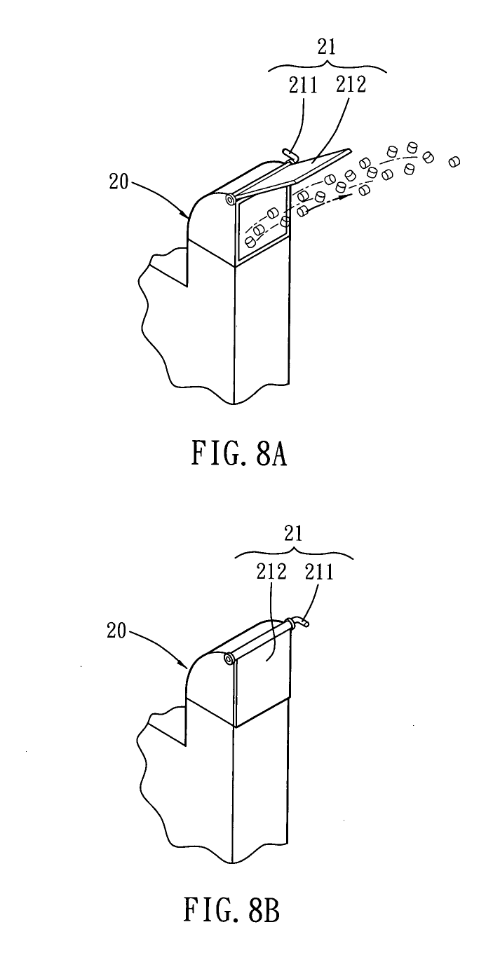

Of course, as shown in FIGS. 8A and 8B, each expelling portion 20 can further include an adjustable blocker 21 that has a controlling handle 211 and an expelling plate 21. By changing the tilted angle (or position) of the expelling plate 21, the operator can control the desired moving direction of the debris or pieces 92 (chopped from the wood material 91).

The advantages and functions of the present invention can be summarized as follows:

[1] The entire structure is solid and safe. The parallel plates and the blocking plates form a solid and safe structure of a housing. When someone needs to repair it, any blocking plate can be detached easily. In addition, it can afford a heavy and high-speed rotational wood chopping cutter. Thus, the entire structure is solid and safe.

[2] The structure is simple. This invention is mainly consisted by several plates (including parallel plates and blocking plates) with proper securing elements (like bolts, screws). So, the assembling work is simple.

[3] It has special guiding slots. There are guiding slots on the parallel plates, so the maintenance work becomes very easy. Once the cutter needs to be replaced due to wear or the like, the operator only needs to detach some blocking plates to take out the wood chopping cutter (via the guiding slots by a hanging device) from the isolated storing space. Therefore, the replacing or repairing works can be simplified significantly.

[4] It has several expelling modes. The debris or pieces can be expelled to the ground, to one side, or both. Such debris or pieces can be used as an organic fertilizer for plants. It is very flexible that this invention has several expelling modes.

The above embodiments are only used to illustrate the present invention, not intended to limit the scope thereof. Many modifications of the above embodiments can be made without departing from the spirit of the present invention.

What is claimed is:

1. A housing for high-speed rotational wood chopping cutter comprising:
a pair of parallel plates having a pair of outer edges, a pair of bearing holders, a pair of guiding slots and an ingress; said pair of outer edges including an egress portion and a plurality of lateral plate edges, said pair of bearing holders being disposed at a central portion of said housing for securing a pair of bearings; said pair of guiding slots including a pair of guide-in portions and a pair of ending portions, said guide-in potions being disposed on a predetermined position of said lateral plates, said ending portions being disposed at said central portion of said housing, said ingress being disposed for inputting a wood material to be cut;
at least one expelling portion for expelling debris or pieces generated during a wood chopping process; and
a plurality of blocking plates connecting between parallel lateral plate edges so as to form a substantially isolated storing space for installing a high-speed rotational wood chopper.

2. The housing for high-speed rotational wood chopping cutter as claimed in claim 1, wherein said pair of guiding slots are sloped or horizontal.

3. The housing for high-speed rotational wood chopping cutter as claimed in claim 2, further comprising two or more auxiliary covering plates to cover on said pair of guiding slots.

4. The housing for high-speed rotational wood chopping cutter as claimed in claim 1, wherein said expelling portion is disposed on said egress portion of said outer edges so as to expel debris or pieces away due to a centrifugal force caused by high-speed rotation.

5. The housing for high-speed rotational wood chopping cutter as claimed in claim 4, wherein said expelling portion is disposed on at least one position selected from an upper corner of said housing, a bottom of said housing, or both.

6. The housing for high-speed rotational wood chopping cutter as claimed in claim 5, wherein said expelling portion further comprises an adjustable blocker which has a controlling handle and an expelling plate.

7. The housing for high-speed rotational wood chopping cutter as claimed in claim 6, wherein said housing is secured on a movable vehicle.
